(19) United States
(12) Patent Application Publication
(10) Pub. No.: US 2014/0008590 A1
(43) Pub. Date: Jan. 9, 2014

(54) HIGH HEAT RESISTANT, LOW ELASTIC MODULUS AND FIRE RESISTANT RESIN AND ITS COMPOUNDS

(71) Applicant: UNIPLUS ELECTRONICS CO., LTD., Chung-Li City (TW)

(72) Inventors: Chung-Hao CHANG, Chung-Li City (TW); Han-Shiang HUAG, Chung-Li City (TW); Li-Wen LIAO, Chung-Li City (TW); Hsiao-Yu CHOU, Dayuan Township (TW)

(73) Assignee: UNIPLUS ELECTRONICS CO., LTD., Chung-Li City (TW)

(21) Appl. No.: 13/712,718

(22) Filed: Dec. 12, 2012

(30) Foreign Application Priority Data
Jul. 4, 2012 (TW) 101124018

(51) Int. Cl. C09K 21/14

(52) U.S. Cl. CPC C09K 21/14
USPC 252/601

(57) ABSTRACT

A high heat resistant, low elastic modulus and fire resistant resin and its compounds are provided. The resin mainly comprises a thermo-hardening resin, a chain extender and a softening agent. Wherein the thermo-hardening resin amounts to 70˜92 wt % in the composite formula, the chain extender amounts to 3˜20 wt % in the composite formula and the softening agent amounts to 5˜10 wt % in the composite formula. The compound composed of 35˜50 wt % of the resin and 50˜65 wt % of a thermal conductive powder has a high thermal conductivity and a low elastic modulus, and is high heat resistant and fire resistant. The compound composed of 60˜95 wt % of the resin and 5˜40 wt % of a multifunctional polyester has a low dielectric constant and a low elastic modulus, and is high heat resistant and fire resistant.

### BACKGROUND OF THE INVENTION

1. Field of Invention

The present invention relates to a high heat resistant, low elastic modulus, fire resistant resin and its compounds and more particularly to a resin which can be used as an dielectric insulating material having a high glass transition temperature and a low elastic modulus, and is high heat resistant and fire resistant. The resin is suitable for using in flexible printed circuit board and rigid printed circuit board, rigid-flex printed circuit board, high thermal conductive and dissipative base plate, multilayer built-up epoxy, high-speed signal transmission materials for cloud computing, IC packaging, LCD packaging and LED packaging.

2. Related Art

In the recent years, electronic information products are developed to be light, slim, compact, and with high functions, high density, three-dimensional structures, high reliability and high operating speed. Consequently, related technology and materials for rigid-flex printed circuit board are highly demanded.

Currently, rigid-flex printed circuit board (PCB) is an electronic component composed of flexible PCBs and rigid PCBs. There is no fixed design pattern or shape for rigid-flex printed circuit board because it is designed to meet the structural requirements. Rigid-flex printed circuit board is categorized into two types based on the manufacturing procedures and the way the boards are combined together. The difference between the two types lies in the technology used to manufacture the boards. For the first type, the flexible and rigid boards are combined together during the manufacturing procedures. The boards share the same blind and buried holes and therefore the circuit can be designed with a higher density. For the second type, the flexible and rigid boards are manufactured separately and then laminated into a single circuit board. There is signal connection but without through holes. Rigid-flex printed circuit board is generally used to name all the rigid-flex PCBs including the two different types mentioned above. Rigid-flex printed circuit board is different from flexible board and rigid board in terms of material and equipment used and manufacturing procedures. Rigid board is mainly made of FR4, while flexible board is mainly made of PI. There are technical difficulties in the combination between the different materials and different thermal contraction rates, and therefore the product stability and reliability are poor. Additionally, because of the characteristics of three-dimensional space disposition of rigid-flex printed circuit board, the X and Y axes directional stress and the withstand for Z axis directional stress are important and needed to be taken into considerations. Currently, modified materials for rigid-flex printed circuit board, such as epoxy or modified resin for meeting the requirements of combination between rigid and flexible boards, are supplied for the rigid board and flexible board manufacturers by the material suppliers. Furthermore, selection of no-flow or very-low-flow prepregs and solder mask ink are also critical in the manufacturing of rigid-flex printed circuit board. Because of the material characteristics and specification differences of rigid-flex printed circuit board, the equipment for laminating and copper-plating has to be modified. The applicability of equipment must be taken into considerations before manufacturing rigid-flex printed circuit board because it can affect the product yield rate and stability.

However, the copper clad laminates employed in the manufacturing of rigid-flex printed circuit board by the flexible or rigid board manufacturers in Taiwan are the same types of copper clad laminates used in the existing board manufacture procedures. Therefore, the yield rate and reliability are poor, the cost is high and the delivery period is long for the rigid-flex printed circuit boards made in Taiwan. Furthermore, new composite materials for manufacturing rigid-flex printed circuit board are difficult to research, develop and evaluate, and the period required for UL-94 certification is long. The problems of poor applicability and delamination are common for new materials used in manufacturing rigid-flex printed circuit board. Therefore, it is urgent and critical for the PCB industry in Taiwan to enhance the supply chain of high-quality materials and related services for combining flexible and rigid boards.

Currently, rigid board is mainly made of FR4, while flexible board is mainly made of PI. There are technical difficulties in the combination between the different materials and different thermal contraction rates, and therefore the product stability and reliability are poor. In order to enhance the product stability and reliability, Hitachi Chemical has employed epoxy as the base to match with modified polyamide-imide (PAI) to produce a thermosetting resin with low elastic modulus, and the resin is further used to produce a PP prepreg or a resin coated copper foil (RCC). The prepreg and copper foil are then employed to produce a rigid board with the multilayer built-up of RCC. Besides that the basic functions of the rigid-flex printed circuit board can be maintained, the thickness of the rigid-flex printed circuit board can be reduced. Therefore, the problems of combination between the materials of rigid and flexible boards do not exist, and the product stability and reliability can be enhanced. Because epoxy is used as the base, brominated epoxy or phosphorus modified epoxy has to be used with inorganic powder to meet the requirement of fire resistance. The use of brominated epoxy does not meet the trend of employing eco-friendly materials. If phosphorus modified epoxy is used with inorganic powder, phosphorus compound is relatively less stable than bromine compound. Furthermore, phosphorus fire retardant is easy to dissolve in water and causes eutrophication in rivers and lakes. It might also cause another environmental issue in handling the phosphorus wastes in the future.

### SUMMARY OF THE INVENTION

A primary objective of the present invention is to provide a resin and its compounds having high glass transition temperatures and low elastic modulus, and are high heat resistant and fire resistant. The resin compounds have high thermal conductivity and low dielectric constant.

In order to achieve the above-mentioned objectives, a resin and its compounds having low elastic modulus, and are high heat resistant and fire resistant are provided. The resin mainly comprises a thermo-hardening resin, a chain extender and a softening agent. Wherein the thermo-hardening resin amounts to 70˜92 wt % in the composite formula, the chain extender amounts to 3˜20 wt % in the composite formula and the softening agent amounts to 5˜10 wt % in the composite formula. The compound composed of 35˜50 wt % of the resin and 50˜65 wt % of a thermal conductive powder has a high thermal conductivity and a low elastic modulus, and is high heat resistant and fire resistant. The compound composed of 60′˜95 wt % of the resin and 5˜40 wt % of a multifunctional polyester has a low dielectric constant and a low elastic modulus, and is high heat resistant and fire resistant.

When the present invention is embodied, the thermo-hardening resin is selected from the groups of polyamide-imide resin, bismaleimide, phenolic resin, epoxy, urea resin, melamine resin, polyimide resin, thermosetting polyester resin, alkyd resin, silicone resin, urethane resin, polyvinyl resin, poly (diallyl phthalate), furan resin, xylene resin, guanamine resin, maleic resin and dicyclopentadiene resin.

When the present invention is embodied, the chain extender comprises diamino diphenyl sulfone (DDS), diamino diphenyl ether (ODA), diamino diphenyl methane (MDA), polyether amine or their compounds.

When the present invention is embodied, the softening agent is selected from the chemical compounds or mixtures of carboxyl-terminated butadiene-acrylonitrile (CTBN) and olefin resin contains polyimide structure.

When the present invention is embodied, the thermo-hardening resin comprises a polyamide-imide resin and a bismaleimide. Wherein the polyamide-imide resin amounts to 23˜62 wt % in the composite formula and the bismaleimide amounts to 30˜69 wt % in the composite formula.

When the present invention is embodied, the structural formula of the polyamide-imide resin is as follows:

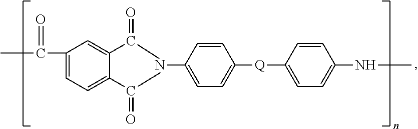

wherein Q is

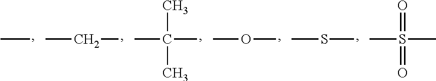

and 10<n<500.

When the present invention is embodied, the structural formula of the bismaleimide is as follows:

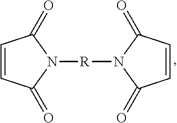

wherein R comprises

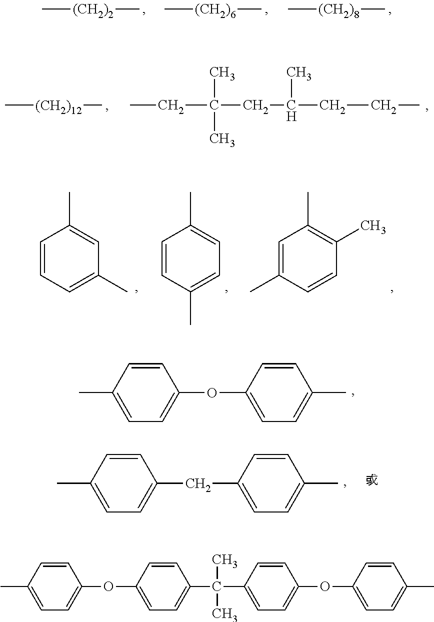

When the present invention is embodied, the compound obtained from mixing the polyamide-imide resin, the bismaleimide, the chain extender and the softening agent is left to react for 2˜8 hours under 100˜150° C. to form a reactant modified bismaleimide resin.

When the present invention is embodied, the thermal conductive powder comprises aluminum oxide, aluminum nitride, silicon carbide, boron nitride or their compounds.

When the present invention is embodied, the structural formula of the multifunctional polyester is as follows:

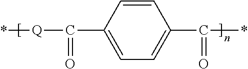

Wherein the structural formula of Q is as follows:

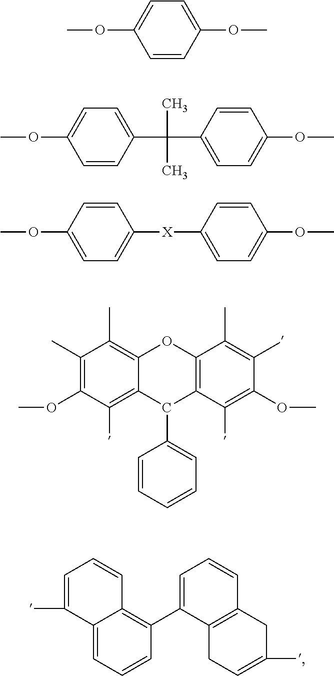

and X: —CH₂, —C(CH₃)₂, —SO₂, and n=integer of 1˜10.

The present invention will become more fully understood by reference to the following detailed description thereof when read in conjunction with the attached drawings.

### BRIEF DESCRIPTION OF THE DRAWINGS

FIG. 1 is a composite illustration of a resin according to an embodiment of the present invention;

FIG. 2 is a composite illustration of a resin compound according to an embodiment of the present invention; and

FIG. 3 is a composite illustration of another resin compound according to an embodiment of the present invention.

### DETAILED DESCRIPTION OF THE INVENTION

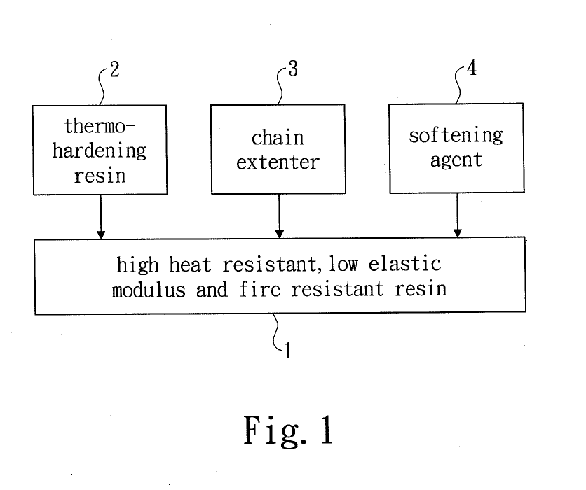

FIG. 1 is a high heat resistant, low elastic modulus, fire resistant resin 1 according to an embodiment of the present invention. The resin is composed of a thermo-hardening resin 2, a chain extender 3 and a softening agent 4.

The thermo-hardening resin 2 amounts to 70˜92 wt % in the composite formula, the chain extender 3 amounts to 3˜20 wt % in the composite formula and the softening agent 4 amounts to 5˜10 wt % in the composite formula.

Wherein, the thermo-hardening resin 2 is selected from the groups of polyamide-imide resin, bismaleimide, phenolic resin, epoxy, urea resin, melamine resin, polyimide resin, thermosetting polyester resin, alkyd resin, silicone resin, urethane resin, polyvinyl resin, poly (diallyl phthalate), furan resin, xylene resin, guanamine resin, maleic resin and dicyclopentadiene resin. The chain extender 3 comprises diamino diphenyl sulfone (DDS), diamino diphenyl ether (ODA), diamino diphenyl methane (MDA), polyether amine or their compounds. The softening agent 4 is selected from the chemical compounds or mixtures of carboxyl-terminated butadiene-acrylonitrile (CTBN) and olefin resin contains polyimide structure.

In this embodiment, the thermo-hardening resin 2 comprises a polyamide-imide resin and a bismaleimide. Wherein the polyamide-imide resin amounts to 23˜62 wt % in the composite formula and the bismaleimide amounts to 30˜69 wt % in the composite formula. Hence in this embodiment, the content of the polyamide-imide resin is between 23˜62 wt %, the content of the bismaleimide is between 30˜69 wt %, the content of the chain extender 3 is between 3˜20 wt % and the content of the softening agent 4 is between 5˜10 wt %.

Wherein, the structural formula of the polyamide-imide resin is as follows:

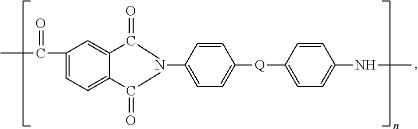

wherein Q is

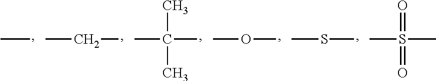

and 10<n<500.

The structural formula of the bismaleimide is as follows:

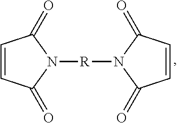

wherein R comprises

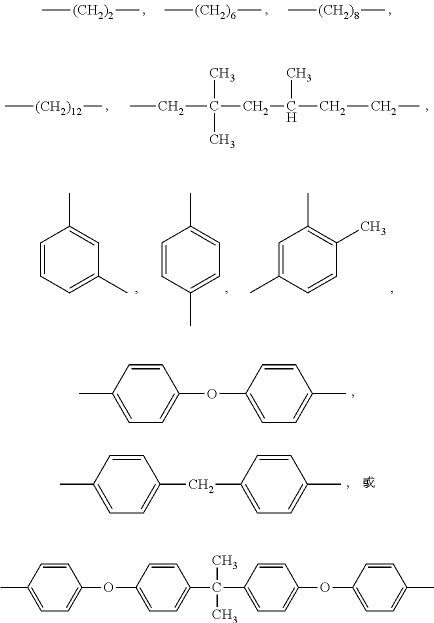

Thereby, when the present invention is embodied, the compound obtained from mixing the polyamide-imide resin, the bismaleimide, the chain extender 3 and the softening agent 4 is left to react for 2˜8 hours under 100˜150° C. to form a reactant modified bismaleimide resin. Practically, the bismaleimide and the chain extender 3 are stirred to react approximately 1˜6 hours under 100˜150° C., then the polyamide-imide resin and the softening agent 4 are added and stirred to react approximately 1˜2 hours under 100˜150° C. to form the homogeneous reactant modified bismaleimide resin.

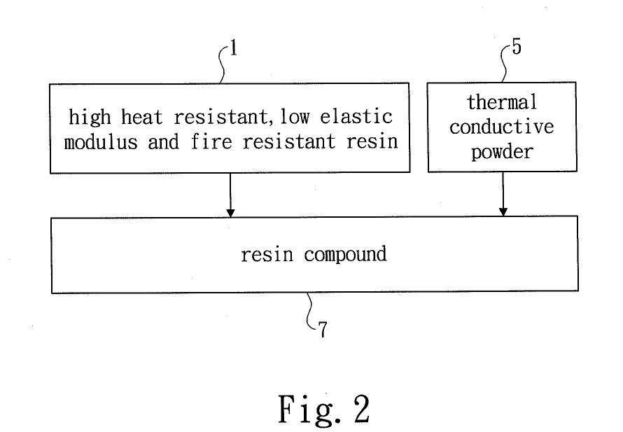

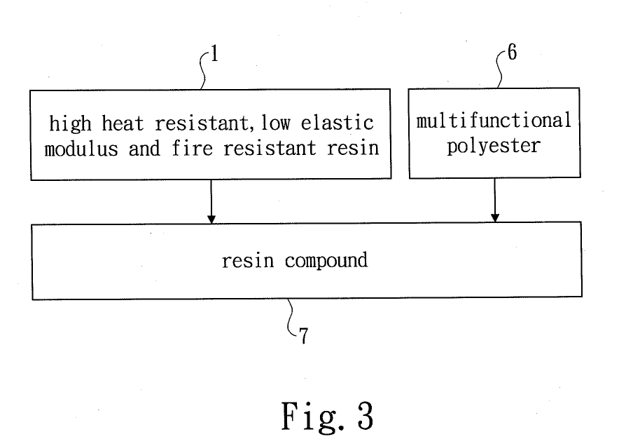

Furthermore, as shown in FIG. 2, a resin compound 7 composed of 35˜50 wt % of the resin formed above and 50˜65 wt % of a thermal conductive powder 5 has a high thermal conductivity and a low elastic modulus, and is high heat resistant and fire resistant. Additionally, as shown in FIG. 3, the resin compound 7 composed of 60′˜95 wt % of the resin formed above and 5˜40 wt % of a multifunctional polyester 6 has a low dielectric constant and a low elastic modulus, and is high heat resistant and fire resistant. Wherein, the thermal conductive powder 5 comprises aluminum oxide, aluminum nitride, silicon carbide, boron nitride or their compounds. The structural formula of the multifunctional polyester 6 is as follows:

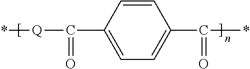

Wherein the structural formula of Q is as follows:

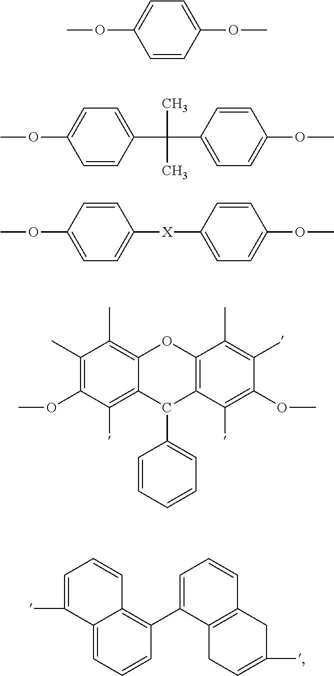

and X: —CH₂, —C(CH₃)₂, —SO₂, and n=integer of 1˜10.

Table 1 listed below shows the comparisons between the embodiments and comparative examples:

TABLE 1

| | | | Chain | Softening | | | Multifunc- | |
|---|---|---|---|---|---|---|---|---|
| | PAI | BMI | Extender | Agent | Epoxy | FR-5 | tional | Al₂O₃ |
| | (g) | (g) | (g) | (g) | (g) | Epoxy | Polyester | (g) |
| Embodiment | 100 | 84.2 | 14.8 | 47.5 | X | X | X | X |
| 1 | | | | | | | | |
| Embodiment | 100 | 84.2 | 11.9 | 46.5 | X | X | X | X |
| 2 | | | | | | | | |
| Embodiment | 100 | 75.4 | 14.0 | 44.3 | X | X | X | X |
| 3 | | | | | | | | |
| Embodiment | 100 | 62.8 | 21.2 | 47.2 | X | X | X | 141.7 |
| 4 | | | | | | | | |
| Embodiment | 100 | 62.8 | 21.2 | 47.2 | x | x | 60.7 | x |
| 5 | | | | | | | | |
| Comparative | 110 | X | 13.3 | X | 67.3 | X | X | X |
| Example 1 | | | | | | | | |
| Comparative | 110 | X | 13.3 | X | 67.3 | X | X | X |
| Example 2 | | | | | | | | |
| Comparative | X | X | X | 32.5 | X | 100 | X | X |
| Example 3 | | | | | | | | |

| | | | | Bends | K | | | |
|---|---|---|---|---|---|---|---|---|
| | Al(OH)₃ | Tg | Modulus | Endured | (W/m | Dk | Df | |
| | (g) | (° C.) | (GPa) | (cycle) | *° C.) | 1 MHz | 1 MHz | UL-94 |
| Embodiment | X | 212 | 4.6 | 170 ± 3 | X | 4.2 | 0.014 | V0 |
| 1 | | | | | | | | |
| Embodiment | X | 210 | 4.3 | 168 ± 3 | X | 4.3 | 0.015 | V0 |
| 2 | | | | | | | | |
| Embodiment | X | 210 | 4.2 | 165 ± 3 | X | 4.4 | 0.017 | V0 |
| 3 | | | | | | | | |
| Embodiment | X | 219 | 8.4 | 125 ± 4 | 1.15 | 5.2 | 0.024 | V0 |
| 4 | | | | | | | | |
| Embodiment | x | 200 | 4.0 | 168 ± 3 | x | 3.3 | 0.007 | V0 |
| 5 | | | | | | | | |
| Comparative | X | 165 | X | 30 ± 2 | X | 4.8 | 0.020 | V1 |
| Example 1 | | | | | | | | |
| Comparative | 114 | 168 | X | 10 ± 2 | X | 4.9 | 0.022 | V0 |
| Example 2 | | | | | | | | |
| Comparative | X | 155 | 16 | 70 ± 4 | X | 4.7 | 0.019 | V0 |
| Example 3 | | | | | | | | |

Wherein:

Embodiment 1: Use a 500 ml glass reactor with three feeding mouths and a stirrer with two blades. Add 84.2 g of bismaleimide (BMI), 14.8 g of diamino diphenyl sulfone (DDS) chain extender and 115 g of dimethylacetamide (DMAC) solvent, and stir under 120° C.˜140° C. until it is dissolved evenly. After it reacts for 1˜6 hours, add 100 g of polyamide-imide resin (PAI; 43.5%) and 47.5 g of softening agent (olefin resin contains polyimide structure; DMF; 30%), and have it stirred to react for 1˜2 hours under 100° C.˜140° C. Let it reduces to room temperature after the reaction, and a low elastic modulus, fire resistant, halogen-free and phosphorous-free compound formulation is obtained.

Embodiment 2: Use a 500 ml glass reactor with three feeding mouths and a stirrer with two blades. Add 84.2 g of bismaleimide (BMI), 11.9 g of diamino diphenyl ether (ODA) and 115 g of dimethylacetamide (DMAC) solvent, and stir under 120° C.˜140° C. until it is dissolved evenly. After it reacts for 1˜3 hours, add 100 g of polyamide-imide resin and 46.5 g of olefin resin contains polyimide structure, and have it stirred to react for 1˜2 hours under 100° C.˜140° C. Let it reduces to room temperature after the reaction, and a low elastic modulus, fire resistant, halogen-free and phosphorous-free compound formulation is obtained.

Embodiment 3: Use a 500 ml glass reactor with three feeding mouths and a stirrer with two blades. Add 75.4 g of bismaleimide (BMI), 14 g of polyether amine and 105 g of dimethylacetamide (DMAC) solvent, and stir under 120° C.˜140° C. until it is dissolved evenly. After it reacts for 1˜6 hours, add 100 g of polyamide-imide resin and 44.3 g of olefin resin contains polyimide structure, and have it stirred to react for 1˜2 hours under 100° C.˜140° C. Let it reduces to room temperature after the reaction, and a low elastic modulus, fire resistant, halogen-free and phosphorous-free compound formulation is obtained.

Embodiment 4: Use a 500 ml glass reactor with three feeding mouths and a stirrer with two blades. Add 62.8 g of bismaleimide (BMI), 21.26 g of diamino diphenyl sulfone (DDS) chain extender and 115 g of dimethylacetamide (DMAC) solvent, and stir under 120° C.˜140° C. until it is dissolved evenly. After it reacts for 1˜6 hours, add 100 g of polyamide-imide resin (PAI; 43.5%) and 47.2 g of softening agent (olefin resin contains polyimide structure; DMF; 30%), and have it stirred to react for 1˜2 hours under 100° C.18 140° C. Let it reduces to room temperature after the reaction, add 141.7 g of aluminum oxide (Al₂O₃, Showa Denko Co.) into the above solution and have it stirred in the reactor. Then, a high heat dissipative, low elastic modulus, fire resistant, halogen-free and phosphorous-free compound is obtained.

Embodiment 5: Use a 500 ml glass reactor with three feeding mouths and a stirrer with two blades. Add 62.8 g of bismaleimide (BMI), 21.26 g of diamino diphenyl sulfone (DDS) chain extender and 115 g of dimethylacetamide (DMAC) solvent, and stir under 120° C.˜140° C. until it is dissolved evenly. After it reacts for 1˜6 hours, add 100 g of polyamide-imide resin (PAI; 43.5%), 47.2 g of softening agent (olefin resin contains polyimide structure; DMF; 30%) and 60.7 g of multifunctional polyester (DIC Japan), and have it stirred to react for 1˜2 hours under 100° C.˜140° C. Let it reduces to room temperature after the reaction, and a fire resistant, halogen-free and phosphorous-free compound with a low dielectric constant and low elastic modulus is obtained.

### COMPARATIVE EXAMPLE 1

Use a 500 ml glass reactor with three feeding mouths and a stirrer with two blades. Add 110 g of polyamide-imide resin (43.5%), 67.3 g of epoxy and 13.3 g of dimethylacetamide (DMAC) solvent, stir under 80° C.˜90° C. until it is dissolved evenly. After it reacts for 2˜4 hours and let it reduces to room temperature, add 13.3 g of diamino diphenyl sulfone (DDS) into the solution and have it stirred in the reactor, and a halogen-free and phosphorous-free compound formulation is obtained.

### COMPARATIVE EXAMPLE 2

Use a 500 ml glass reactor with three feeding mouths and a stirrer with two blades. Add 110 g of polyamide-imide resin (43.5%), 67.3 g of epoxy and 13.3 g of dimethylacetamide (DMAC) solvent, stir under 80° C.˜90° C. until it is dissolved evenly. After it reacts for 2˜4 hours and let it reduces to room temperature, add 13.3 g of diamino diphenyl sulfone (DDS) and 114 g of aluminium hydroxide Al(OH)₃ into the above solution and have it stirred in the reactor, and a fire resistant, halogen-free and phosphorous-free compound formulation is obtained.

### COMPARATIVE EXAMPLE 3

Use a 500 ml glass reactor with three feeding mouths and a stirrer with two blades. Add 110 g of FR-5 epoxy resin (65%) and 32.5 g of carboxyl-terminated butadiene-acrylonitrile (CTBN) (MEK solvent, solid content: 20%), have it stirred evenly under room temperature, and a fire resistant and halogen-free compound formulation is obtained. Wherein the formula for FR-5 epoxy resin is as follows:

| | |
|---|---|
| D.E.R. 542 (Dow Epoxy Resin, a product name of | 125 g. |
| Dow Chemical) | |
| D.E.R. 331 (Dow Epoxy Resin) | 125 g. |
| Diamino diphenyl sulfone (DDS) | 20 g. |
| Olefin resin contains polyimide structure (DMF) | 146 g. |
| Boron trifluoride-monoethylamine (BF₃•MEA) | 1.5 g. |

Thereby, the physical properties of the embodiments 1˜5 and the comparative examples 1˜3 are listed in the Table 1 above. As shown in Table 1, the properties of fire resistance, high Tg and low elastic modulus of the embodiments 1˜5 are better than those of the comparative examples, and the comparative example 3 is a bromated FR-5 epoxy resin.

Therefore, the materials used for the compounds of the present invention are halogen-free and phosphorous-free. After a thermo-hardening resin such as the polyamide-imide resin, and the bismaleimide are mixed with the chain extender and the softening agent, the solution is heated to react under appropriate reactive temperature and time period to form the homogeneous reactant modified bismaleimide resin. By controlling the proportions of the materials, a halogen-free, phosphorous-free, high heat resistant, low elastic modulus and fire resistant resin compound with different flexibility, gel time and gel flow can be obtained. The compounds of the present invention have excellent flexibility and heat stability, and are free from any halogen and phosphorus fire retardant, and are conformed to the flame retardant UL-94VO certification without having to add any inorganic powder.

According to the disclosure mentioned above, the high heat resistant, low elastic modulus and fire resistant resin and its compounds of the present invention can achieve the objectives, and have industrial and practical values.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A high heat resistant, low elastic modulus and fire resistant resin, comprising:
a thermo-hardening resin amounted to 70˜92 wt % in the composite formula;
a chain extender amounted to 3˜20 wt % in the composite formula; and
a softening agent amounted to 5˜10 wt % in the composite formula.

2. The high heat resistant, low elastic modulus and fire resistant resin as claimed in claim 1, wherein the thermo-hardening resin is selected from the groups of polyamide-imide resin, bismaleimide, phenolic resin, epoxy, urea resin, melamine resin, polyimide resin, thermosetting polyester resin, alkyd resin, silicone resin, urethane resin, polyvinyl resin, poly (diallyl phthalate), furan resin, xylene resin, guanamine resin, maleic resin and dicyclopentadiene resin.

3. The high heat resistant, low elastic modulus and fire resistant resin as claimed in claim 1, wherein the thermo-hardening resin comprises a polyamide-imide resin and a bismaleimide, wherein the polyamide-imide resin amounts to 23˜62 wt % in the composite formula and the bismaleimide amounts to 30˜69 wt % in the composite formula.

4. The high heat resistant, low elastic modulus and fire resistant resin as claimed in claim 3, wherein the compound obtained from mixing the polyamide-imide resin, the bismaleimide, the chain extender and the softening agent is left to react for 2˜8 hours under 100˜150° C. to form a reactant modified bismaleimide resin.

5. The high heat resistant, low elastic modulus and fire resistant resin as claimed in claim 3, wherein the structural formula of the polyamide-imide resin is as follows: 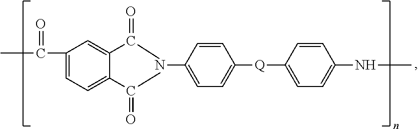
wherein Q is 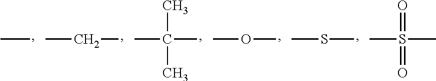
and 10<n<500.

6. The high heat resistant, low elastic modulus and fire resistant resin as claimed in claim 3, wherein the structural formula of the bismaleimide is as follows: 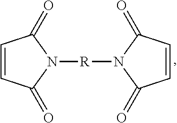
wherein R comprises

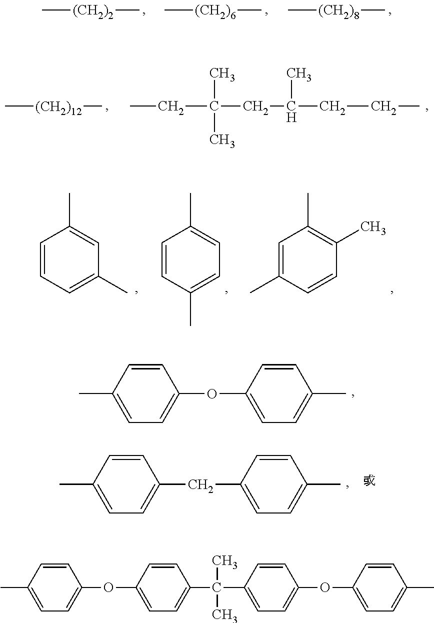

7. The high heat resistant, low elastic modulus and fire resistant resin as claimed in claim 1, wherein the chain extender comprises diamino diphenyl sulfone (DDS), diamino diphenyl ether (ODA), diamino diphenyl methane (MDA), polyether amine or their compounds.

8. The high heat resistant, low elastic modulus and fire resistant resin as claimed in claim 1, wherein the softening agent is selected from the chemical compounds or mixtures of carboxyl-terminated butadiene-acrylonitrile (CTBN) and olefin resin contains polyimide structure.

9. A high heat resistant, low elastic modulus and fire resistant resin compound, comprising:
the heat resistant, low elastic modulus and fire resistant resin as claimed in claim 1; and
a thermal conductive powder.

10. The high heat resistant, low elastic modulus and fire resistant resin compound as claimed in claim 9, wherein the proportional weight of the high heat resistant, low elastic modulus and fire resistant resin in the high heat resistant, low elastic modulus and fire resistant resin compound is between 35˜50%.

11. The high heat resistant, low elastic modulus and fire resistant resin compound as claimed in claim 9, wherein the proportional weight of the thermal conductive powder in the high heat resistant, low elastic modulus and fire resistant resin compound is between 50˜65%.

12. The high heat resistant, low elastic modulus and fire resistant resin compound as claimed in claim 9, wherein the thermal conductive powder comprises aluminum oxide, aluminum nitride, silicon carbide, boron nitride or their compounds.

13. A high heat resistant, low elastic modulus and fire resistant resin compound, comprising:
the heat resistant, low elastic modulus and fire resistant resin as claimed in claim 1; and
a multifunctional polyester.

14. The high heat resistant, low elastic modulus and fire resistant resin compound as claimed in claim 13, wherein the proportional weight of the high heat resistant, low elastic modulus and fire resistant resin in the high heat resistant, low elastic modulus and fire resistant resin compound is between 60˜95%.

15. The high heat resistant, low elastic modulus and fire resistant resin compound as claimed in claim 13, wherein the proportional weight of the multifunctional polyester in the high heat resistant, low elastic modulus and fire resistant resin compound is between 5[40%.

16. The high heat resistant, low elastic modulus and fire resistant resin compound as claimed in claim 13, wherein the structural formula of the multifunctional polyester is as follows: 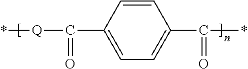
wherein the structural formula of Q is as follows: 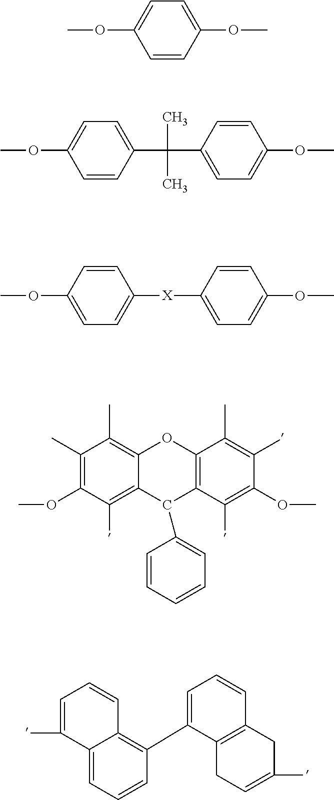
and X: —CH₂, —C(CH₃)₂, —SO₂, and n=integer of 1˜10.
